(19) United States
(12) Patent Application Publication
(10) Pub. No.: US 2004/0136503 A1
(43) Pub. Date: Jul. 15, 2004

(54) Recording, storing, and accessing of telephone conversations

(76) Inventor: Sheldon Kass, North Brunswick, NJ (US)

Correspondence Address: Mr. Walter J. Tencza Jr., 10 Station Place, Suite 3, Metuchen, NJ, 08840, US

(21) Appl. No.: 10/339,432

(22) Filed: Jan. 9, 2003

(51) Int. Cl. H04M 1/64

(52) U.S. Cl. 379/67.1; 379/88.22

(57) ABSTRACT

A method is provided comprising answering a telephone call for a business entity, wherein the telephone call comes from a customer located at a customer communications device, and connecting the customer communications device with a business representative of the business entity, wherein the business representative is located at a business representative communications device. The method may further include recording a telephone conversation between the customer and the business representative, storing the telephone conversation as a data file, and supplying the business entity with an identification code, which identifies the data file. Alternatively the identification code may be provided by the business entity.

### FIELD OF THE INVENTION

This invention relates to methods and apparatus concerning recording of telephone conversations.

### BACKGROUND OF THE INVENTION

The web or Internet has become a major tool for commerce, especially in the process of a customer researching a product and ordering a product. The ordering of a product can be done online using e-commerce or can be ordered by calling a company's phone number, such as a toll free number, and placing an order by speaking to a live person. As it turns out orders are placed by customers calling telephone number instead of placing an order on the Internet. This occurs for a few reasons. Customers are fearful of entering their credit card information into a computer system. Customers find it time consuming and inconvenient to enter the full order online. Customers prefer live person to person contact when they place their order. Customers often have further questions regarding their order. As a result, a large part of web or Internet actual ordering is done via the use of a customer calling either a company's toll free number or a company's non toll free number, and placing an order by live voice communication.

The problem for companies with the use of live voice to voice ordering is that the information communicated from a customer to a company has be manually entered by a representative of the company. It is obvious, that voice ordering is subject to errors. Errors range from the customer meant one model number but said a different model number, to the customer saying the right model number to the company but the order taker (or business representative) entering a different model number. In either case, the customer may receive the wrong product. There may be disputes over who is at fault. The customer may cancel his credit card payment or may sue.

The obvious answer is to record the conversation between the customer and the company. Now the company can listen to the order conversation and determine who is the fault. The company can even play the recorded conversation for the customer to hear. Some companies do record their conversations. However, the problem today with recording conversations is that the company needs elaborate in house equipment, and has to manage a voluminous amount of recorded conversation voice files. Today, the main difficulty with utilizing recorded conversations comes down to managing the collections of voice files. These voice files must be stored and must be organized by date and time. When a company representative needs to locate an actual conversation voice file of a placed order, the company representative may have to listen to all the conversations that took place about the date and time that the order took place. It often takes a few weeks to track down the proper voice file.

### SUMMARY OF THE INVENTION

The present invention in one or more embodiments provides a system, method, or apparatus for recording telephone conversations between customers and business representatives. A recording service communications device, processor, and memory are provided in one embodiment. The recording service processor typically is comprised of one or more computers. The recording service communications device typically receives a phone call from a customer to a toll free number or a normal non toll free number (designated for a business operated by the recording service). The recording service processor, in response to the telephone call, dials a business's or company's designated telephone number, and connects the customer to a business representative of the business or company. Since each call made by the customer to the toll free or non toll free number goes through the recording service, the recording service is in a position to record all of the conversations between customers who dial the toll free number and business representatives. The business or company does not need any equipment on their premises (other than typically a communications device to receive or make phone calls).

Each time a call comes in for the business, the processor of the recording service prepares a unique identification code that is linked to the recorded conversation file. When the order or customer-business representative phone conversation is completed and the call is over, the processor of the recording service will typically automatically speak that unique identification code to the business or company representative. The person representing the company may enter that code onto one or more order documents, such as an invoice, or they may enter the code into their computer system.

The recording service will typically include and maintain a database in memory, such as electronic or computer memory, of unique identification codes, such as numbers, and recorded conversation voice files. At any late date, when a need arises between the customer and the business representative, the business can retrieve the unique identification code from the documentation that it has, such as an invoice or order form, or from their computer system, The business representative can then call a special number provided by the recording service, and enter the unique identification code. Immediately the company or business will hear the proper voice recording. The company, business, or business representative can give the customer simple instructions, as how to hear the telephone conversation.

### BRIEF DESCRIPTION OF THE DRAWINGS

FIG. 1 shows a block diagram of an apparatus or system in accordance with an embodiment of the present invention;

FIG. 2 shows a flow chart of a method in accordance with an embodiment of the present invention for use with the apparatus of FIG. 1;

FIG. 3 shows a flow chart of a method in accordance with another embodiment of the present invention;

FIG. 4 shows a flow chart of a method in accordance with another embodiment of the present invention; and

FIG. 5 shows a flow chart of a method in accordance with another embodiment of the present invention.

### DETAILED DESCRIPTION OF THE DRAWINGS

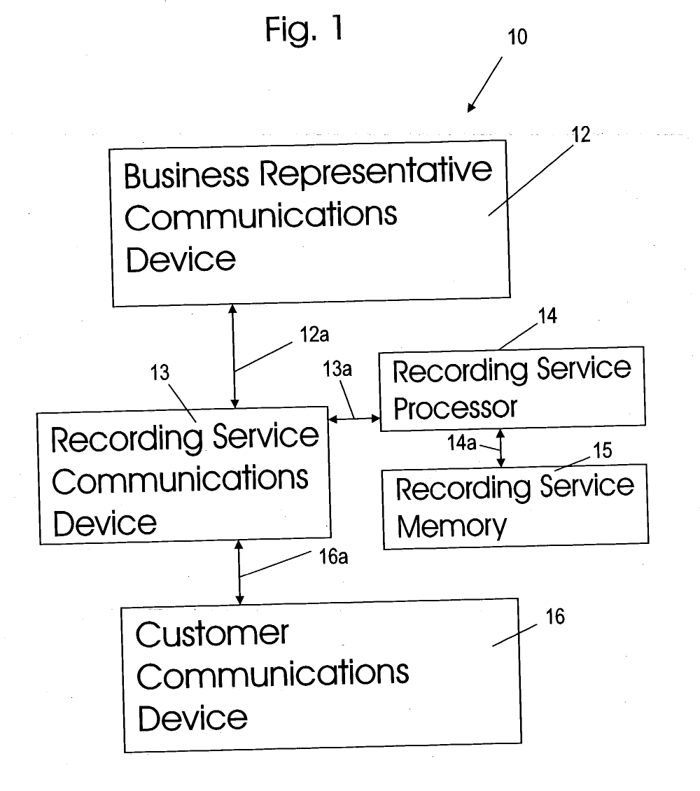

FIG. 1 shows a block diagram of an apparatus 10 or system in accordance with an embodiment of the present invention. The apparatus or system 10 includes a business representative communications device 12, a recording service communications device 13, a recording service processor 14, a recording service memory 15, and a customer communications device 16. The business representative communications device 12 may be electrically connected by a communications line 12a to the recording service communications device 13. The recording service communications device 13 may be electrically connected to the recording service processor 14 by communications line 13a. The recording service processor 14 may be connected to recording service memory 15 by communications line 14a. The recording service communications device 13 may be electrically connected by a communications line 16a to the customer communications device 16. The communications lines 12a, 13a, 14a, and 16a may be any type of connection such as hardwired, wireless, optical, or any other known type of communications connection.

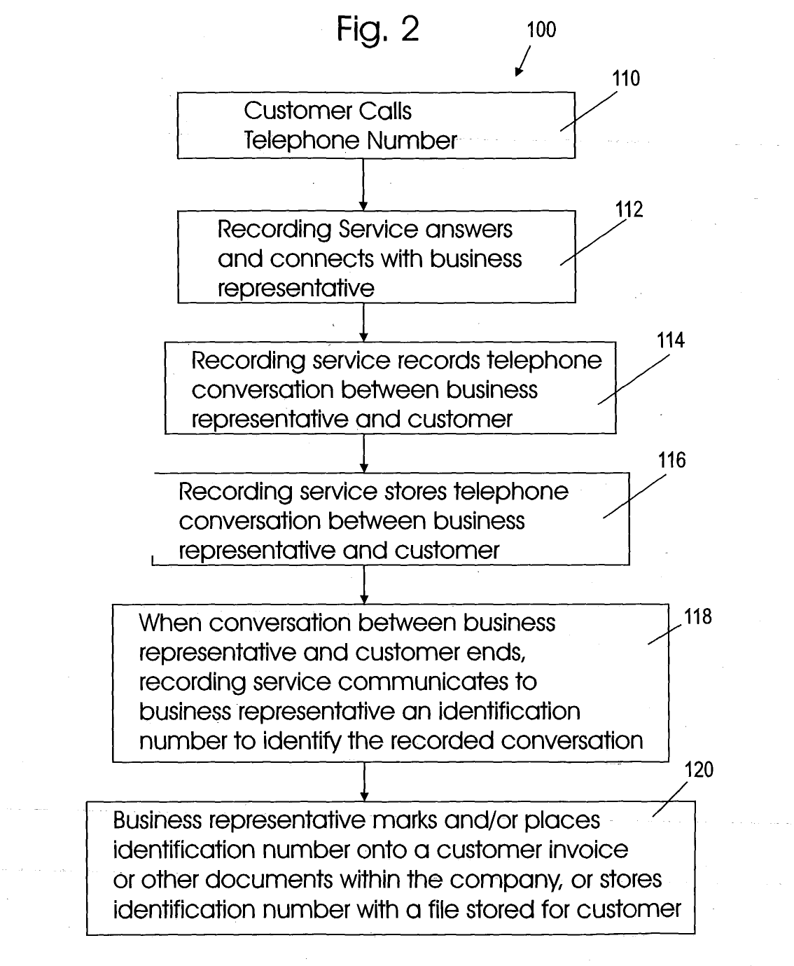

FIG. 2 shows a flow chart 100 of a method in accordance with an embodiment of the present invention for use with the apparatus 10 of FIG. 1. At step 110 a customer calls a telephone number using customer communications device 16. At step 112 the recording service processor 14 answers the telephone call from the customer through communications device 13 and automatically connects the customer with a business representative at business representative communications device 12. The recording service processor 14 may be comprised of a computer and/or other equipment, which records the telephone conversation between the customer (who is using communications device 16) and the business representative (who is using business representative communications device 12) at step 114. The recording service processor 14 may store the conversation between the customer and the business representative in a computer memory 15 of the recording service at step 116.

At step 118, during the call or upon termination of the conversation between the customer and the business representative, the recording service processor 14, through communications device 13, may communicate to the business representative communications device 12 (and thus also to the business representative), an identification number to identify the recorded conversation between the customer and the business representative. At step 120, the business representative may mark and/or place the identification number onto a invoice for the customer or may mark and/or place the identification number on other documents within the company, or may store the identification number with a file stored for a customer.

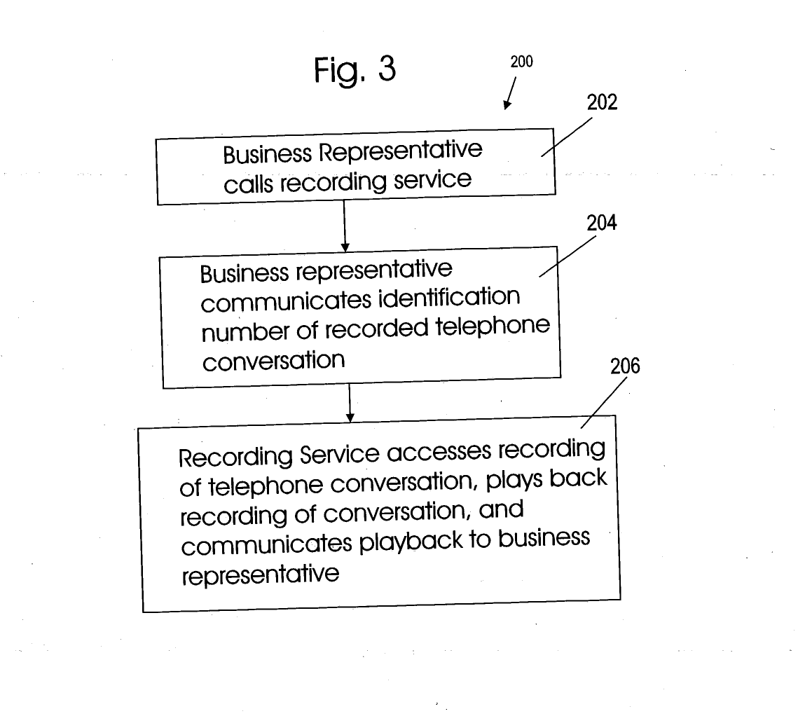

FIG. 3 shows a flow chart 200 of a method in accordance with another embodiment of the present invention. At step 202 a business representative, such as for example the same business representative referred to with reference to FIG. 2, or for example another business representative of the same business referred to with reference to FIG. 2, may call the recording service communications device 13. The business representative may communicate the identification number to the recording service processor 14 (through communications device 13) for the previous telephone conversation referred to with reference to FIG. 2, at step 204. At step 206 the recording service processor 14 may access the recording of the previous telephone conversation, (from the memory 15) between the customer and the business representative and may play back and communicate the playback of the conversation to the business representative communications device 12 (and thus also to the business representative).

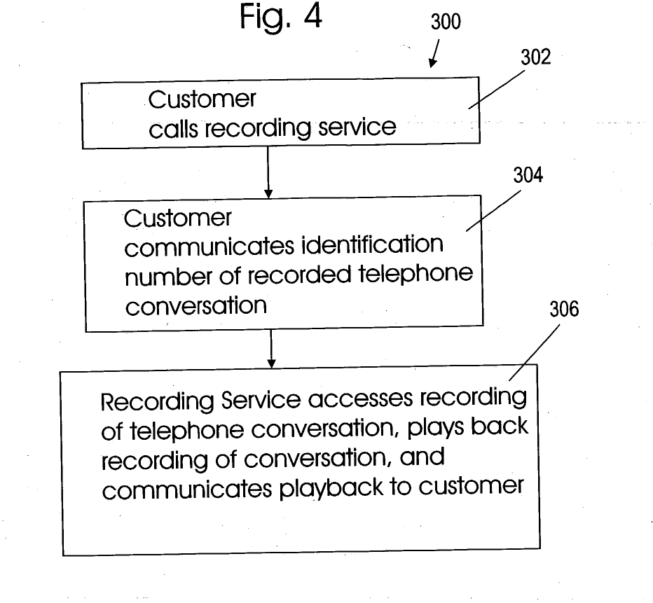

FIG. 4 shows a flow chart 300 of a method in accordance with another embodiment of the present invention. At step 302 the customer, such as the customer referred to with reference to FIG. 2, may call the recording service communications device 13 via, for example, customer communications device 16. At step 304, the customer may communicate the identification number of the recorded telephone conversation to the recording service processor 14 (through communications device 13). At step 306, the recording service processor 14 may access (from memory 15) the recording of the telephone conversation and may play back and communicate (via the communications device 13) the playback of the conversation to the customer communications device 16, and thus to the customer.

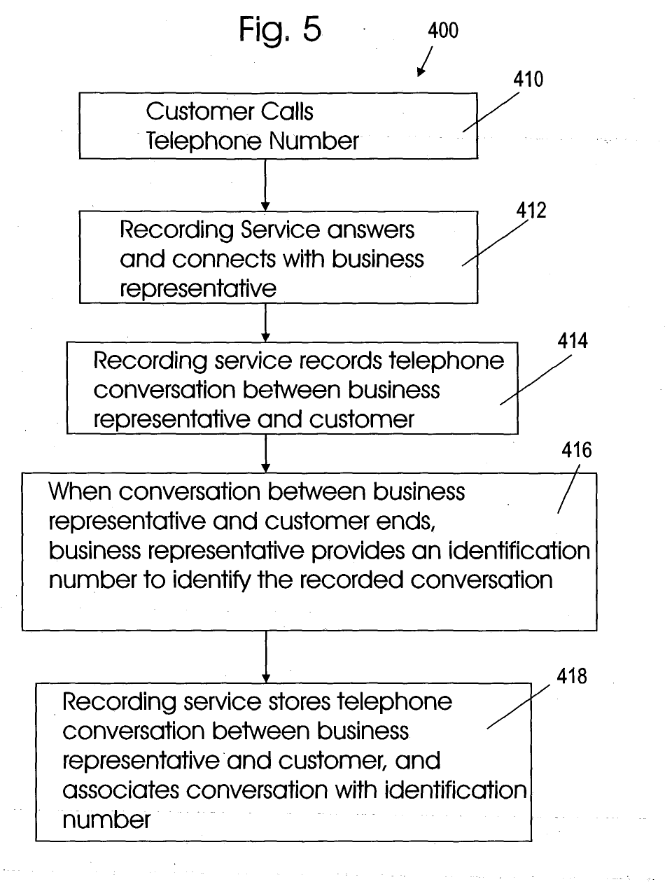

FIG. 5 shows a flow chart 400 of a method in accordance with another embodiment of the present invention. The method shown by flow chart 400 is somewhat similar to the method shown by flow chart 100 of FIG. 2, with some exceptions. Steps 410, 412, and 414 may be identical to steps 110, 112, and 114 of FIG. 2. However, in step 416, when the conversation between the business representative and the customer ends, the business representative may provide an identification number or code to identify the recorded conversation. The business representative may provide the identification number in response to a prompt from the recording service or recording service processor 14, that the business representative should enter an identification number or code. The identification number entered may be a confirmation number, which for example, is used in industries such as the travel industry to confirm a reservation. At step 418 the recording service processor 14 may store data corresponding to the telephone conversation in memory 15, and the processor 14 may associate the data with the identification number or code provided by the business representative. For example, the data may be associated with the identification number, by linking the identification number with the data as an index or a pointer so that the identification number points to the data. If the processor 14 is provided with the identification number it will be able to locate the data corresponding to the specific telephone conversation.

The present invention is applicable to many industries, including the travel industry and the securities industry.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of:
answering a telephone call for a business entity, wherein the telephone call comes from a customer located at a customer communications device;
connecting the customer communications device with a business representative of the business entity, wherein the business representative is located at a business representative communications device;
recording a telephone conversation between the customer and the business representative;
storing the telephone conversation as a data file; and
supplying the business entity with an identification code, which identifies the data file.

2. The method of claim 1 wherein
the business entity is supplied with the identification code through a recording service communications device.

3. The method of claim 1 wherein
the business entity is supplied with the identification code during the call or upon the termination of the telephone conversation.

4. The method of claim 1 further comprising
associating the identification code with a document of the business entity.

5. The method claim 4 wherein
the document is an invoice of the business entity.

6. The method of claim 4 wherein
the identification code is associated with the document by marking the identification code onto the document.

7. The method of claim 5 wherein
the identification code is associated with the document by marking the identification code onto the document.

8. The method of claim 1 further comprising
receiving the identification code; and
playing back a recording of the telephone conversation.

9. The method of claim 8 wherein
the identification code is received from the business entity.

10. The method of claim 8 wherein
the identification code is received from the customer.

11. An apparatus comprising
a recording service communications device;
a processor; and
a memory;
wherein the recording service communications device answers a telephone call for a business entity, wherein the telephone call comes from a customer located at a customer communications device;
wherein the processor connects the customer communications device with a business representative of the business entity, wherein the business representative is located at a business representative communications device;
wherein the processor records a telephone conversation between the customer and the business representative;
wherein the processor stores the telephone conversation as a data file in the memory; and
wherein the processor supplies the business entity with an identification code, which identifies the data file.

12. The apparatus of claim 11
wherein the processor supplies the business entity with the identification code through the recording service communications device.

13. The apparatus of claim 11 wherein
the business entity is supplied with the identification code during the call or upon the termination of the telephone conversation.

14. The apparatus of claim 11 wherein.
the processor associates the identification code with a document of the business entity.

15. The apparatus of claim 14 wherein
the document is an invoice of the business entity.

16. The apparatus of claim 14 wherein
the processor associates the identification code with the document by marking the identification code onto the document.

17. The apparatus of claim 15 wherein
the processor associates the identification code with the document by marking the identification code onto the document.

18. The apparatus of claim 11 wherein
the processor receives the identification code; and
plays back a recording of the telephone conversation.

19. The apparatus of claim 18 wherein
the identification code is received from the business entity.

20. The apparatus of claim 18 wherein
the identification code is received from the customer.

21. A method comprising the steps of:
answering a telephone call for a business entity, wherein the telephone call comes from a customer located at a customer communications device;
connecting the customer communications device with a business representative of the business entity, wherein the business representative is located at a business representative communications device;
recording a telephone conversation between the customer and the business representative;
receiving an identification code from the business entity;
and associating the identification code with a data file that contains the telephone conversation, so that the identification code can be used to find the data file.

22. An apparatus comprising
a recording service communications device;
a processor; and
a memory;
wherein the recording service communications device answers a telephone call for a business entity, wherein the telephone call comes from a customer located at a customer communications device;
wherein the processor connects the customer communications device with a business representative of the business entity, wherein the business representative is located at a business representative communications device;
wherein the processor records a telephone conversation between the customer and the business representative;
wherein the processor receives an identification code from the business entity, and associates the identification code with a data file which contains the recorded telephone conversation, so that the identification code can be used to find the data file.
